(19) United States
(12) Patent Application Publication
(10) Pub. No.: US 2016/0171164 A1
(43) Pub. Date: Jun. 16, 2016

(54) CONNECTED SYSTEMS, DEVICES, AND METHODS INCLUDING CANNABIS PROFILE MANAGEMENT

(71) Applicant: Craig E. Kinzer, Issaquah, WA (US)

(72) Inventor: Craig E. Kinzer, Issaquah, WA (US)

(21) Appl. No.: 14/968,678

(22) Filed: Dec. 14, 2015

Related U.S. Application Data
(60) Provisional application No. 62/092,257, filed on Dec. 16, 2014.

(51) Int. Cl. G06F 19/00

(52) U.S. Cl. CPC G06F 19/322; G06F 19/363; G06F 19/3418

(57) ABSTRACT

Systems, Devices, and Methods are described that enable users to connect via a client device to one or more, enterprise devices, remote devices, client devices, and the like to manage, receive, utilize, and the like cannabis related services and products. Also described are connected systems, devices, and methods for managing treatments associated with phyto-cannabinoid unit dose forms for treating various diseases or disorders.

### PRIORITY CLAIM

This application claims the benefit of U.S. Provisional Application No. 62/092,257, filed on Dec. 16, 2014, which is incorporated by reference herein in its entirety.

### SUMMARY

In an aspect, the present disclosure is directed to, among other things, a cannabis e-commerce device. In an embodiment, the cannabis e-commerce device includes an e-commerce cannabis interface configured to receive cannabis experience information from a client device, a mobile device, a wearable device, a connected device, and the like. In an embodiment, the e-commerce cannabis interface includes circuitry configured to receive and store cannabis experience information from one or more of a smart device, a smart eyewear device, or a smart wearable device. In an embodiment, the e-commerce cannabis interface includes circuitry configured to receive and store cannabis experience information from one or more of a cell phone device, a computer device, a desktop computer device, a laptop computer device, a managed node device, a notebook computer device, a remote controller, a tablet device, a wearable device, or an application interface with a smart device. In an embodiment, the cannabis e-commerce device includes a cannabis client interface configured to generate cannabis management information responsive to receiving the cannabis experience information. In an embodiment, the cannabis e-commerce device includes a vaporizer device interface configured to negotiate an authorization protocol and to exchange cannabis experience information with the vaporizer device.

In an aspect, the present disclosure is directed to, among other things, a device including circuitry configured to generate cannabis management information responsive to one or more inputs indicative of a user-specific cannabis management profile. In an embodiment, the device includes circuitry configured to communicate cannabis management information to an associated client device. In an embodiment, the device includes circuitry configured to associate cannabis management information to user-specific product information or to user-specific service information. In an embodiment, the device includes circuitry configured to generate user-specific informatics regarding use, customization, effectiveness, and the like, responsive to one or more inputs indicative of a user-specific cannabis management profile. In an embodiment, the device includes circuitry configured to communicate a notification to the associated client device responsive to a comparison of the one or more inputs indicative of a user-specific cannabis management profile to at least one threshold condition.

In an aspect, the present disclosure is directed to, among other things, a method including receiving cannabis experience information from a client device. In an embodiment, the method includes generating cannabis management information responsive to receiving the cannabis experience information from the client device. In an embodiment, the method includes negotiating an authorization protocol with a vaporizer device, and exchanging cannabis experience information with the vaporizer device.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE FIGURES

FIG. 1 is perspective views of a system including a device according to an embodiment.

FIG. 2 is perspective views of a system including a device according to an embodiment.

FIG. 3 show a flow diagram of a method according to one embodiment.

FIG. 4 is perspective views of a system including a device according to an embodiment.

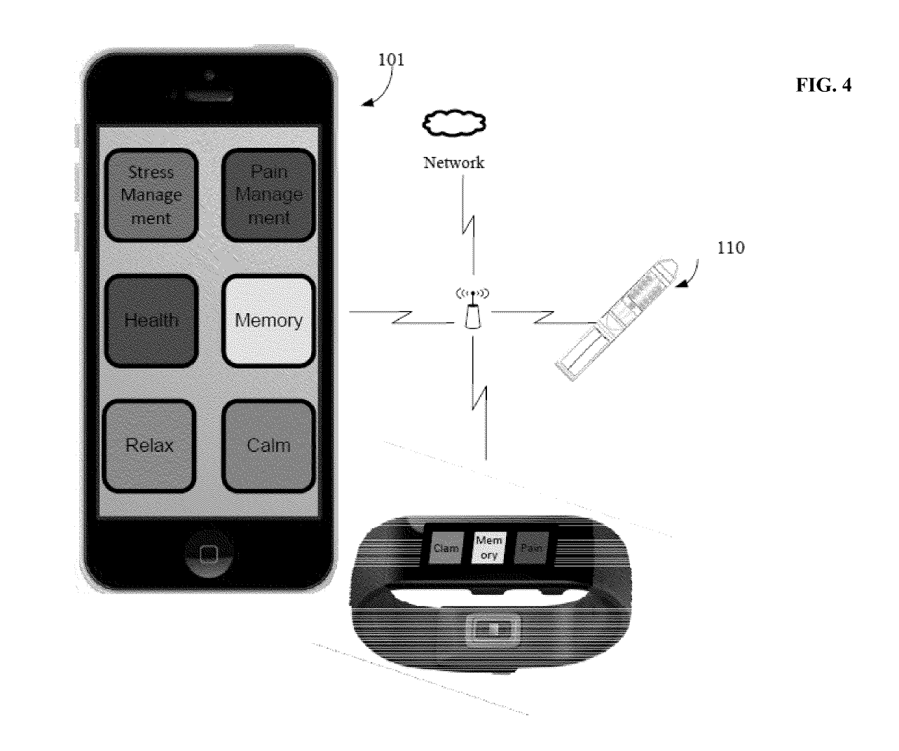

### DETAILED DESCRIPTION

In an embodiment, connected technologies and methodologies enable users to connect via a client device to one or more client devices, enterprise devices, remote devices, and the like to manage, receive, utilize, deliver, and the like cannabis related services and products. For example, in an embodiment, connected technologies and methodologies enable users to customize an experience associated with cannabis related services and products. Connected technologies and methodologies enable users to manage, receive, deliver, utilize, and the like user-specific experiences associated with cannabis related services and products.

Connected technologies methodologies such as connected health technologies enable users to connect and engage with remote resources, other users, client services, enterprise services, or the like. Connected technologies methodologies enable users to connect via a client device to one or more client devices, enterprise devices (e.g., a network device, a server, a cloud server, retailer server device, retailer network device, a computer device, a laptop computer device, a notebook computer device, a desktop computer device, a mobile device, a tablet device, a managed node device, and the like), remote devices, and the like. Non-limiting examples of connected technologies methodologies can be found in U.S. Pat. No. 8,856,748 (Issued Oct. 7, 2014) (which is incorporated herein by reference).

Connected technologies methodologies enable users to better self-manage services and information that they receive, deliver, provide, etc. For example, connected health technologies allow users to receive and deliver care outside of traditional health care settings. Connected health technologies offer opportunities for user to better self-manage their care. Examples of connected health technologies include client devices including mobile medical apps, mobile medical systems, wearable technology, medical device data systems, wireless technologies, Bluetooth technologies, and the like. Connected health technologies encompasses programs in tele-health, remote care, disease management, lifestyle management, and the like. Connected health technologies leverage existing technologies such as connected devices, smart devices, wearable connected devices, existing networks, internet services, cellular networks, and the like.

In an embodiment, connected technologies and methodologies enable users to connect via a client device to one or more client devices, enterprise devices, remote devices, and the like to manage, receive, utilize, and the like services and products related to cannabinoid compositions and manage conditions associates with cannabinoid composition treatments.

Cannabinoid receptors are part of the cannabinoid receptor system in the brain and are involved in a variety of physiological processes including nociception (pain sensation), appetite, lipid metabolism, gastrointestinal motility, cardiovascular modulation, motor activity, mood, and memory. See e.g., Panagiotis et al., The Neuroprotective Role of Endocannabinoids against Chemical-induced Injury and Other Adverse Effects. Journal of Applied Toxicology 33.4: 246-64 Web (2013) (which is incorporated herein by reference). In an embodiment, cannabinoids, cannabidiols, cannabinols, and the like extracted from Cannabis sativa L, may act at peripheral sites and yield analgesia through the action on CB1 and CB2 receptors. See e.g., Jorge et al., J. Pain Res.;4:11-24. doi: 10.2147/JPR.S9492 (December 2010) (which is incorporated herein by reference). In an embodiment, cannabidiols may have anxiolytic effects both in humans and in animals. See e.g., Bergamaschi et al., Neuropsychopharmacology, 36(6): 1219-1226. doi: 10.1038/npp.2011.6 (May 2011) (which is incorporated herein by reference). In an embodiment, cannabinoids may be effective in treating chemotherapy-induced emesis. See e.g., Williamson et al., Cannabinoids in clinical practice, Drugs, 60(6):1303-14 (December 2000) (which is incorporated herein by reference).

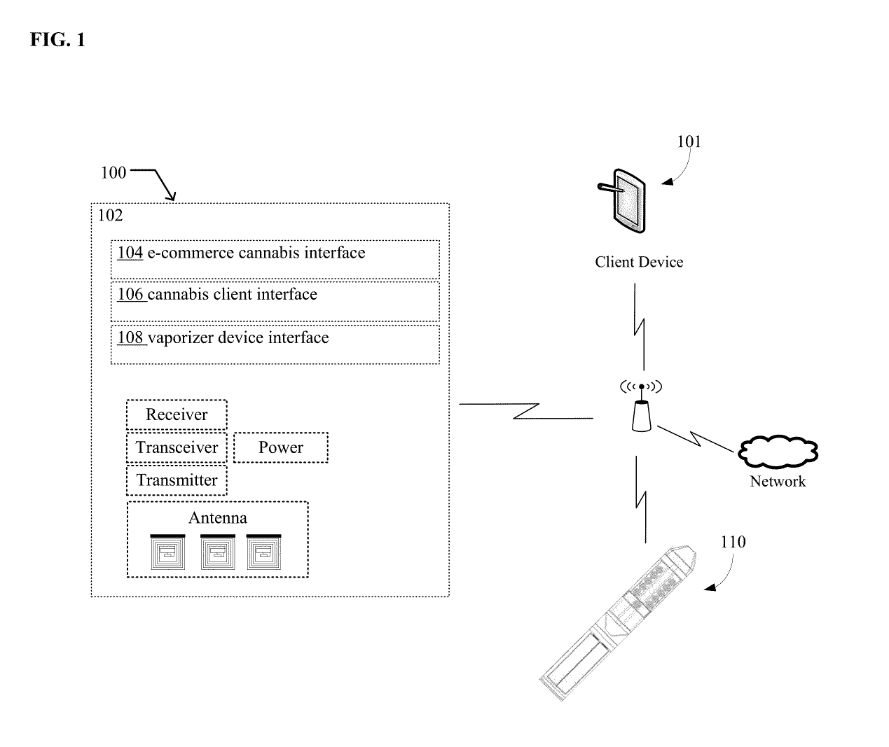

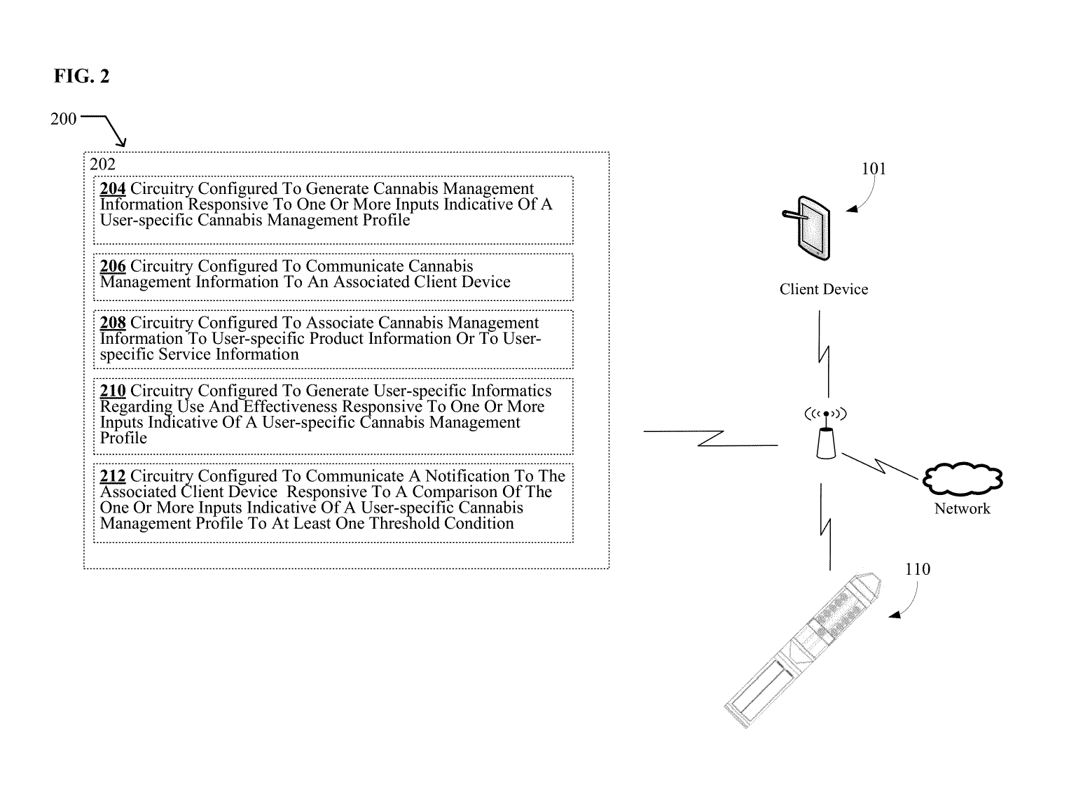

FIGS. 1, 2, and show a system 100 including a cannabis e-commerce device 102 in which one or more methodologies or technologies can be implemented, for example, to manage, receive, utilize, and the like services and products related to treating cannabinoid receptor-mediated diseases or disorders.

In an embodiment, the e-commerce device 102 includes an e-commerce cannabis interface 104 configured to receive cannabis experience information from a client device 101.

In an embodiment, an interface, such as an e-commerce cannabis interface 104, includes among other things, one or more computing devices such as a processor (e.g., a microprocessor), a central processing unit (CPU), a digital signal processor (DSP), an application-specific integrated circuit (ASIC), a field programmable gate array (FPGA), or the like, or any combinations thereof, and can include discrete digital or analog circuit elements or electronics, or combinations thereof. In an embodiment, an interface includes one or more ASICs having a plurality of predefined logic components. In an embodiment, an interface includes one or more FPGAs, each having a plurality of programmable logic components.

In an embodiment, an interface includes one or more components operably coupled (e.g., communicatively, electromagnetically, magnetically, ultrasonically, optically, inductively, electrically, capacitively coupled, or the like) to each other. In an embodiment, an interface includes one or more remotely located components. In an embodiment, remotely located components are operably coupled, for example, via wireless communication. In an embodiment, remotely located components are operably coupled, for example, via one or more receivers, transmitters, transceivers, antennas, or the like. In an embodiment, an e-commerce cannabis interface 104 includes an interface having one or more routines, data structures, interfaces, and the like. In an embodiment, an interface one or more receivers, transmitters, transceivers, antennas, or the like.

In an embodiment, an interface includes memory that, for example, stores instructions or information. For example, in an embodiment, an e-commerce cannabis interface 104 includes memory that stores, for example, cannabis experience information. Non-limiting examples of memory include volatile memory (e.g., Random Access Memory (RAM), Dynamic Random Access Memory (DRAM), or the like), non-volatile memory (e.g., Read-Only Memory (ROM), Electrically Erasable Programmable Read-Only Memory (EEPROM), Compact Disc Read-Only Memory (CD-ROM), or the like), persistent memory, or the like. Further non-limiting examples of memory include Erasable Programmable Read-Only Memory (EPROM), flash memory, or the like. In an embodiment, the memory is coupled to, for example, one or more computing devices by one or more instructions, information, or power buses.

In an embodiment, an interface includes one or more computer-readable media drives, interface sockets, Universal Serial Bus (USB) ports, memory card slots, or the like, and one or more input/output components such as, for example, a graphical user interface, a display, a keyboard, a keypad, a trackball, a joystick, a touch-screen, a mouse, a switch, a dial, or the like, and any other peripheral device. In an embodiment, an interface includes one or more user input/output components, user interfaces, client devices, or the like, that are operably coupled to at least one computing device configured to control (e.g., electrical, electromechanical, software-implemented, firmware-implemented, or other control, or combinations thereof) at least one parameter associated with, for example, dynamically displaying one or more analytics associated with a consumer event.

In an embodiment, the e-commerce cannabis interface 104 includes circuitry configured to exchange and store cannabis experience information from one or more client devices 101. Non-limiting examples of client devices 101 include smart devices, smart eyewear devices, smart wearable devices, and the like. Further non-limiting examples of client devices 101 include cell phone devices, computer devices, desktop computer devices, laptop computer devices, managed node devices, notebook computer devices, remote controllers, tablet devices, wearable devices, application interface with smart devices, and the like. Further non-limiting examples of client devices 101 include mobile client devices.

In an embodiment, the e-commerce cannabis interface 104 includes circuitry configured to receive and store cannabis experience information from one or more of a smart device, a smart eyewear device, or a smart wearable device. In an embodiment, the e-commerce cannabis interface 104 includes circuitry configured to receive and store cannabis experience information from one or more of a cell phone device, a computer device, a desktop computer device, a laptop computer device, a managed node device, a notebook computer device, a remote controller, a tablet device, a wearable device, or an application interface with a smart device. In an embodiment, the e-commerce cannabis interface 104 includes circuitry configured to receive and store cannabis experience information from one or more mobile client devices 101. In an embodiment, the e-commerce cannabis interface 104 includes circuitry configured to receive and store cannabis experience information from one or more vaporizer devices 110 (e.g., a vape pen, an e-cigarette, a nebulizer, and the like).

In an embodiment, the e-commerce device 102 includes an e-commerce cannabis interface 104 configured to exchange information associated with treating cannabinoid receptor-mediated diseases or disorders of the central nervous system (CNS). Diseases or disorders of the central nervous system include, among others, depression, anxiety, attention deficit hyperactivity disorder (ADHD) and the like. Further CNS diseases or disorders include ulcerative colitis; disorders where increased angiogenesis may be beneficial (e.g., diabetes, gangrene, or the like); disorders in which a lack of dopamine or serotonin is involved; disorders in which improved cognition may be beneficial (e.g., Alzheimer's disease, Parkinson's disease, schizophrenia, or the like); Tourette's Syndrome; nausea, vomiting, anorexia nervosa, spasticity, major depressive disorder, cachexia, wasting syndromes, appetite suppression, glaucoma, epilepsy, Dravet Syndrome, multiple sclerosis, asthma, and pain, including pain involved with cancer, HIV, migraines and generalized neuropathic pain. In an embodiment, one or more of the disclosed methodologies or technologies can be implemented to treat any disease or disorder that elicits a therapeutic response in a patient using an active agent such as a cannabinoid, or the like.

In an embodiment, the e-commerce device 102 includes an e-commerce cannabis interface 104 configured to exchange information with a client device 101 associated with a unit dose of at least one active agent. Non-limiting examples of active agents include cannabinoids cannabidiols, cannabigerols, cannabichromenes, cannabinols, and the like. Non-limiting examples of cannabinoids includes those found naturally in cannabis or members of the Cannabis species (e.g. phyto-cannabinoids, phyto-cannabichromenes, phyto-cannabidiols, phyto-cannabidiolic acids, phyto-cannabigerols, phyto-cannabinols, phyto-cannabidivarins, phyto-tetrahydrocannabinolic acids, phyto-tetrahydrocannabivarins, and the like), including Cannabis sativa, Cannabis indica, and Cannabis ruderalis, and chemovars, cultivars, genetic crosses, self-crosses and hybrids thereof. Further non-limiting examples of active agents include synthetic cannabinoids and human cannabinoids (i.e., endocannabinoids), including nabilone, dronabinol, and rimonabant.

Further non-limiting examples of active agents include Δ⁹-tetrahydrocannabinol; Δ⁹-tetrahydrocannabiorcol; Δ⁹-tetrahydrocannabivarin; 10-O-ethylcannabitriol; 6a,7,10a-trihydroxytetrahydrocannabinol; 7,8-dehydro-10-O-ethylcannabitriol; 9,10-epoxycannabitriol; cannabichromene; cannabicitran; cannabicyclol; cannabidiol; cannabidivarin; cannabielsoin; cannabigerol; cannabinol; dihydrocannabinol; and the like, and analogues and derivatives thereof. See e.g., Ross et al., Phytochem Anal, January-February; 16(1):45-(2005). Further non-limiting examples of active agents include Δ⁹ tetrahydrocannabinol, Δ⁸ tetrahydrocannabinol, cannabidiol, cannabigerol, cannabichromene, cannabinol, and the like, and analogues and derivatives thereof, including ether, ester and amide derivatives. Further non-limiting examples of active agents include phyto-cannabinoids (THC), phyto-cannabichromenes (CBC), phyto-cannabidiols (CBD), phyto-cannabidiolic acids (CBD-A), phyto-cannabigerols (CBG), phyto-cannabinols (CBN), phyto-cannabidivarins (CBDV), phyto-tetrahydrocannabinolic acids (THC-A), phyto-tetrahydrocannabivarins (THCV), and the like.

In an embodiment, the e-commerce device 102 includes an e-commerce cannabis interface 104 configured to exchange information with a client device 101 associated with a unit dose including at least one terpene. Non-limiting examples of terpenes include borneol, β-caryophyllene, cineole, delta-3-carene, limonene, D-linalool, 3-myrcene, pinene, pulegone, sabinene, terpineol, and the like.

In an embodiment, the e-commerce device 102 includes an e-commerce cannabis interface 104 configured to exchange information with a client device 101 associated with a unit dose of at least one nootropic agent. Non-limiting examples of nootropic agents include memory enhancers, neuro enhancers, cognitive enhancers, intelligence enhancers, and the like, or mixtures thereof. Further non-limiting examples of nootropic agents include 8-sulfocholecystokinin octapeptide, acetylcarnitine, ACTH (4-7), ACTH (4-10), adafenoxate, aniracetam, cerebrolysin, choline, cytidine diphosphate choline, donepezil, ergoloid mesylates, etimizol, etiracetam, galantamine, meclofenoxate, nefiracetam, nicergoline, nicotinoyl-GABA, oxiracetam, pantogab, picamilon, piracetam, SA 4503, TA 0910, tacrine, vinpocetine, and the like, or mixtures thereof. See e.g., “NLM Controlled Vocabulary.” National Center for Biotechnology Information. U.S. National Library of Medicine, n.d. Web. 3 Jul. 2014. In an embodiment, the unit dose package 102 includes at least a second storage location 108 having a unit dose of a nonselective COX inhibitor and at least one nootropic agent.

In an embodiment, the e-commerce device 102 includes a cannabis client interface 106 configured to generate cannabis management information responsive to receiving the cannabis experience information. In an embodiment, the cannabis client interface 106 includes circuitry configured to generate and display at least one real-time statistic generated based on a comparison of the user-specific cannabis experience information to at least one of parameter associated with enterprise-specific threshold criteria.

In an embodiment, the cannabis client interface 106 includes circuitry configured to communicate a notification to a client device 101 a based on a comparison of the cannabis experience information to at least one of parameter associated with enterprise-specific threshold criteria. In an embodiment, the cannabis client interface 106 includes circuitry configured to communicate a push notification to a client device 101 based on a comparison of the cannabis experience information to at least one of parameter associated with enterprise-specific threshold criteria. In an embodiment, the cannabis client interface 106 includes circuitry configured to communicate a push notification to a client device 101, the push notification including a dosage form package order based on a user specific target profile.

In an embodiment, the cannabis client interface 106 includes circuitry configured to communicate a push notification to a client device 101, the push notification including information associated with a target terpene/terpenoid profile. In an embodiment, the cannabis client interface 106 includes circuitry configured to communicate a push notification to a client device 101, the push notification including information associated with a target phyto-cannabinoid:terpene profile. In an embodiment, the cannabis client interface 106 includes circuitry configured to communicate a push notification to a client device 101, the push notification including information associated with a target terpene composition.

In an embodiment, the cannabis client interface 106 includes circuitry configured to communicate a push notification to a client device 101, the push notification including information associated with a target flavor profile. For example, in an embodiment, the cannabis client interface 106 includes circuitry configured to communicate a push notification to a client device 101, the push notification including information associated with a target composition including one or more of a borneol, (β-caryophyllene, cineole, delta-3-carene, limonene, D-linalool, β-myrcene, pinene, pulegone, sabinene, or terpineol.

In an embodiment, the cannabis client interface 106 includes circuitry configured to communicate a push notification to a client device 101, the push notification including information associated with a target cultivar profile. In an embodiment, the cannabis client interface 106 includes circuitry configured to communicate a push notification to a client device 101, the push notification including user-specific dose-form fabrication information associated with a first unit dose form including at least one phyto-cannabinoid.

In an embodiment, the cannabis client interface 106 includes circuitry configured to provide an end user access to an application through a web browser on a client device 101.

In an embodiment, the e-commerce cannabis interface 104 includes circuitry configured to receive and store or more inputs indicative of a user-specific flavor profile. In an embodiment, the cannabis client interface includes circuitry configured to generate cannabis management information responsive to receiving the user-specific cannabis experience information.

In an embodiment, the e-commerce cannabis interface 104 includes circuitry configured to receive and store one or more inputs indicative of a user-specific auto-immune disease profile. In an embodiment, the cannabis client interface is configured to generate cannabis management information responsive to receiving the one or more inputs indicative of a user-specific auto-immune disease profile.

In an embodiment, the e-commerce cannabis interface 104 includes circuitry configured to receive and store one or more inputs indicative of a user-specific pain mitigation profile. In an embodiment, the cannabis client interface is configured to generate cannabis management information responsive to receiving the one or more inputs indicative of a user-specific pain mitigation profile.

In an embodiment, the e-commerce cannabis interface 104 includes circuitry configured to receive and store one or more inputs indicative of a user-specific stress mitigation profile. In an embodiment, the cannabis client interface is configured to generate cannabis management information responsive to receiving the one or more inputs indicative of a user-specific stress mitigation profile.

In an embodiment, the e-commerce cannabis interface 104 includes circuitry configured to receive and store one or more inputs indicative of a user-specific desired feeling/results profile. In an embodiment, the cannabis client interface is configured to generate cannabis management information responsive to receiving the one or more inputs indicative of a user-specific desired feeling/results profile.

In an embodiment, the e-commerce device 102 includes a vaporizer device interface 108 configured to negotiate an authorization protocol and to exchange cannabis experience information with the vaporizer device 110. In an embodiment, the e-commerce device 102 includes a vaporizer device interface 108 configured to exchange cannabis experience information with the vaporizer device 110. In an embodiment, the e-commerce device 102 includes a vaporizer device interface 108 configured to exchange cannabis management information with the vaporizer device 110. In an embodiment, the e-commerce device 102 includes a vaporizer device interface 108 configured to initiating a discovery and a registration protocol that allows the cannabis e-commerce device and vaporizer device 110 to find each other and negotiate one or more pre-shared keys.

FIG. 2 shows a system 200 including a device 202 in which one or more methodologies or technologies can be implemented, for example, to manage, receive, utilize, and the like services and products related to treating cannabinoid receptor-mediated diseases or disorders. In an embodiment, the device 202 includes circuitry 204 configured to generate cannabis management information responsive to one or more inputs indicative of a user-specific cannabis management profile. Non-limiting examples of cannabis management information include user-specific terpene/terpenoid/CBD/THC information, user-specific flavor profile information, user-specific auto-immune diseases information, user-specific pain mitigation profile information, user-specific stress mitigation profile information, user-specific desired feeling/results profile information, user-specific dose form information, and the like.

In an embodiment, circuitry includes, among other things, one or more computing devices such as a processor (e.g., a microprocessor), a central processing unit (CPU), a digital signal processor (DSP), an application-specific integrated circuit (ASIC), a field programmable gate array (FPGA), or the like, or any combinations thereof, and can include discrete digital or analog circuit elements or electronics, or combinations thereof. In an embodiment, circuitry includes one or more ASICs having a plurality of predefined logic components. In an embodiment, circuitry includes one or more FPGA having a plurality of programmable logic components.

In an embodiment, the device 202 includes circuitry having one or more components operably coupled (e.g., communicatively, electromagnetically, magnetically, ultrasonically, optically, inductively, electrically, capacitively coupled, or the like) to each other. In an embodiment, circuitry includes one or more remotely located components. In an embodiment, remotely located components are operably coupled via wireless communication. In an embodiment, remotely located components are operably coupled via one or more receivers, transceivers, or transmitters, or the like.

In an embodiment, circuitry includes one or more memory devices that, for example, store instructions or data. For example, in an embodiment, the device 202 includes one or more memory devices that store cannabis experience information, cannabis management information, and the like. Non-limiting examples of one or more memory devices include volatile memory (e.g., Random Access Memory (RAM), Dynamic Random Access Memory (DRAM), or the like), non-volatile memory (e.g., Read-Only Memory (ROM), Electrically Erasable Programmable Read-Only Memory (EEPROM), Compact Disc Read-Only Memory (CD-ROM), or the like), persistent memory, or the like. Further non-limiting examples of one or more memory devices include Erasable Programmable Read-Only Memory (EPROM), flash memory, or the like. The one or more memory devices can be coupled to, for example, one or more computing devices by one or more instructions, data, or power buses. In an embodiment, the device 202 includes one or more memory device that stores, for example, information regarding user-specific terpene/terpenoid/CBD/THC information, user-specific flavor profile information, user-specific auto-immune diseases information, user-specific pain mitigation profile information, user-specific stress mitigation profile information, user-specific desired feeling/results profile information, and the like. In an embodiment, circuitry includes one or more computer-readable media drives, interface sockets, Universal Serial Bus (USB) ports, memory card slots, or the like, and one or more input/output components such as, for example, a graphical user interface, a display, a keyboard, a keypad, a trackball, a joystick, a touch-screen, a mouse, a switch, a dial, or the like, and any other peripheral device. In an embodiment, circuitry includes one or more user input/output components that are operably coupled to at least one computing device to control (electrical, electromechanical, software-implemented, firmware-implemented, or other control, or combinations thereof) at least one parameter associated with, for example,

In an embodiment, circuitry includes a computer-readable media drive or memory slot that is configured to accept signal-bearing medium (e.g., computer-readable memory media, computer-readable recording media, or the like). In an embodiment, a program for causing a system to execute any of the disclosed methods can be stored on, for example, a computer-readable recording medium (CRMM), a signal-bearing medium, or the like. Non-limiting examples of signal-bearing media include a recordable type medium such as a magnetic tape, floppy disk, a hard disk drive, a Compact Disc (CD), a Digital Video Disk (DVD), Blu-Ray Disc, a digital tape, a computer memory, or the like, as well as transmission type medium such as a digital and/or an analog communication medium (e.g., a fiber optic cable, a waveguide, a wired communications link, a wireless communication link (e.g., receiver, transceiver, or transmitter, transmission logic, reception logic, etc.). Further non-limiting examples of signal-bearing media include, but are not limited to, DVD-ROM, DVD-RAM, DVD+RW, DVD-RW, DVD-R, DVD+R, CD-ROM, Super Audio CD, CD-R, CD+R, CD+RW, CD-RW, Video Compact Discs, Super Video Discs, flash memory, magnetic tape, magneto-optic disk, MINIDISC, non-volatile memory card, EEPROM, optical disk, optical storage, RAM, ROM, system memory, web server, or the like.

In an embodiment, the device 202 includes circuitry having one or more modules optionally operable for communication with one or more input/output components that are configured to relay user output and/or input. In an embodiment, a module includes one or more instances of electrical, electromechanical, software-implemented, firmware-implemented, or other control devices. Such devices include one or more instances of memory, computing devices, antennas, power or other supplies, logic modules or other signaling modules, gauges or other such active or passive detection components, piezoelectric transducers, shape memory elements, micro-electro-mechanical system (MEMS) elements, or other actuators.

In an embodiment, the device 202 includes circuitry 206 configured to communicate cannabis management information to an associated client device 101.

In an embodiment, the device 202 includes circuitry 208 configured to associate cannabis management information to user-specific product information or to user-specific service information.

In an embodiment, the device 202 includes circuitry 210 configured to generate user-specific informatics regarding use and effectiveness responsive to one or more inputs indicative of a user-specific cannabis management profile.

In an embodiment, the device 202 includes circuitry 212 configured to communicate a notification to the associated client device 101 responsive to a comparison of the one or more inputs indicative of a user-specific cannabis management profile to at least one threshold condition.

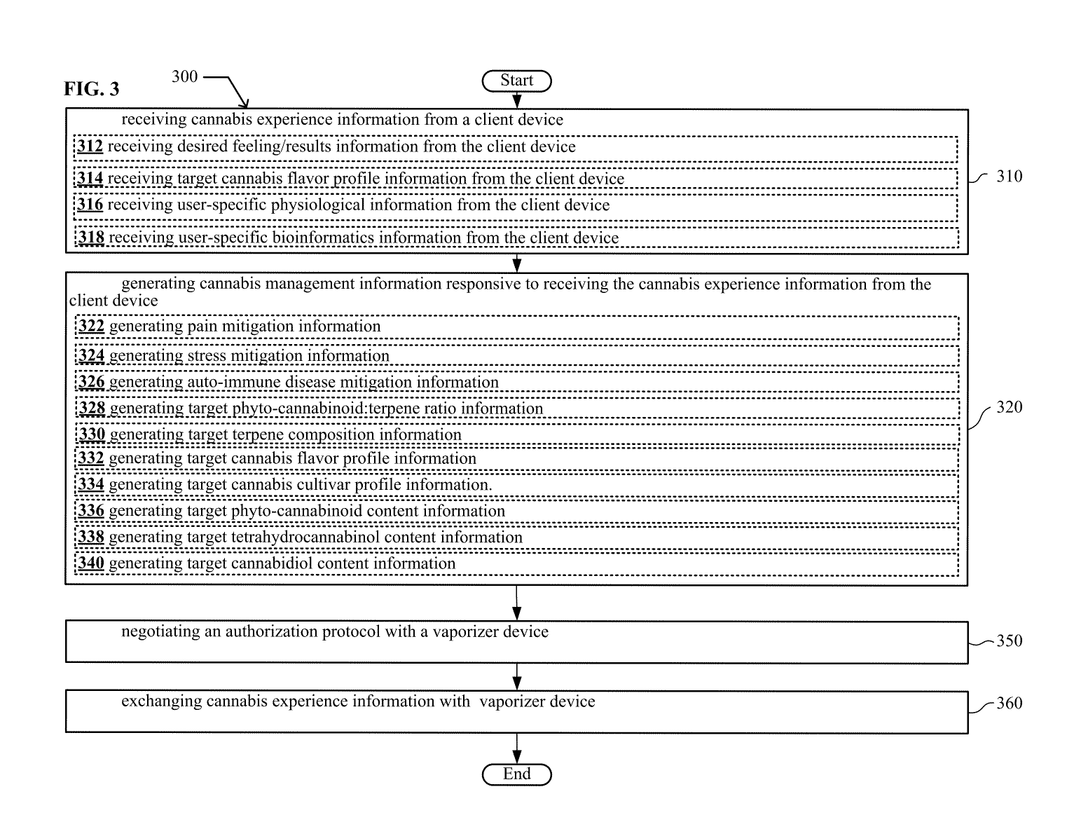

FIG. 3 shows a method 300. At 310, the method 300 includes receiving cannabis experience information from a client device 101. At 312, receiving the cannabis experience information from the client device 101 includes receiving desired feeling/results information from the client device 101. At 314, receiving the cannabis experience information from the client device 101 includes receiving target cannabis flavor profile information from the client device 101. At 316, receiving the cannabis experience information from the client device 101 includes receiving user-specific physiological information from the client device 101. At 318, receiving the cannabis experience information from the client device 101 includes receiving user-specific bioinformatics information from the client device 101.

At 320, the method 300 includes generating cannabis management information responsive to receiving the cannabis experience information from the client device 101. At 322, generating the cannabis management information includes generating pain mitigation information. At 324, generating the cannabis management information includes generating stress mitigation information. At 326, generating the cannabis management information includes generating auto-immune disease mitigation information. At 326, generating the cannabis management information includes generating target terpene/terpenoid composition information. At 328, generating the cannabis management information includes generating target phyto-cannabinoid:terpene ratio information. At 330, generating the cannabis management information includes generating target terpene composition information. At 332, generating the cannabis management information includes generating target cannabis flavor profile information. At 334, generating the cannabis management information includes generating target cannabis cultivar profile information.

At 336, generating the cannabis management information includes generating target phyto-cannabinoid content information. At 338, generating the cannabis management information includes generating target tetrahydrocannabinol content information. At 340, generating the cannabis management information includes generating target cannabidiol content information.

At 350, the method 300 includes negotiating an authorization protocol with a vaporizer device. At 360, the method 300 includes exchanging cannabis experience information with the vaporizer device.

It is noted that FIG. 3 denotes “start” and “end” positions. However, nothing herein should be construed to indicate that these are limiting and it is contemplated that other or additional steps or functions can occur before or after those described in FIG. 3.

The claims, description, and drawings of this application may describe one or more of the instant technologies in operational/functional language, for example as a set of operations to be performed by a computer. Such operational/functional description in most instances can be specifically-configured hardware (e.g., because a general purpose computer in effect becomes a special purpose computer once it is programmed to perform particular functions pursuant to instructions from program software).

Importantly, although the operational/functional descriptions described herein are understandable by the human mind, they are not abstract ideas of the operations/functions divorced from computational implementation of those operations/functions. Rather, the operations/functions represent a specification for the massively complex computational machines or other means. As discussed in detail below, the operational/functional language must be read in its proper technological context, i.e., as concrete specifications for physical implementations.

The logical operations/functions described herein are a distillation of machine specifications or other physical mechanisms specified by the operations/functions such that the otherwise inscrutable machine specifications may be comprehensible to the human mind. The distillation also allows one of skill in the art to adapt the operational/functional description of the technology across many different specific vendors' hardware configurations or platforms, without being limited to specific vendors' hardware configurations or platforms.

Some of the present technical description (e.g., detailed description, drawings, claims, etc.) may be set forth in terms of logical operations/functions. As described in more detail in the following paragraphs, these logical operations/functions are not representations of abstract ideas, but rather representative of static or sequenced specifications of various hardware elements. Differently stated, unless context dictates otherwise, the logical operations/functions are representative of static or sequenced specifications of various hardware elements. This is true because tools available to implement technical disclosures set forth in operational/functional formats—tools in the form of a high-level programming language (e.g., C, java, visual basic), etc.), or tools in the form of Very high speed Hardware Description Language (“VIDAL,” which is a language that uses text to describe logic circuits-)—are generators of static or sequenced specifications of various hardware configurations. This fact is sometimes obscured by the broad term “software,” but, as shown by the following explanation, what is termed “software” is a shorthand for a massively complex interchanging/specification of ordered-matter elements. The term “ordered-matter elements” may refer to physical components of computation, such as assemblies of electronic logic gates, molecular computing logic constituents, quantum computing mechanisms, etc.

For example, a high-level programming language is a programming language with strong abstraction, e.g., multiple levels of abstraction, from the details of the sequential organizations, states, inputs, outputs, etc., of the machines that a high-level programming language actually specifies. See, e.g., High-level Programming Language., Wikipedia. Wikimedia Foundation, 18 Jan. 2014. Web. 4 Feb. 2014. In order to facilitate human comprehension, in many instances, high-level programming languages resemble or even share symbols with natural languages. See, e.g., Natural Language., Wikipedia. Wikimedia Foundation, 14 Jan. 2014. Web. 4 Feb. 2014.

It has been argued that because high-level programming languages use strong abstraction (e.g., that they may resemble or share symbols with natural languages), they are therefore a “purely mental construct” (e.g., that “software”—a computer program or computer—programming—is somehow an ineffable mental construct, because at a high level of abstraction, it can be conceived and understood in the human mind). This argument has been used to characterize technical description in the form of functions/operations as somehow “abstract ideas.” In fact, in technological arts (e.g., the information and communication technologies) this is not true.

[56] The fact that high-level programming languages use strong abstraction to facilitate human understanding should not be taken as an indication that what is expressed is an abstract idea. In an embodiment, if a high-level programming language is the tool used to implement a technical disclosure in the form of functions/operations, it can be understood that, far from being abstract, imprecise, “fuzzy,” or “mental” in any significant semantic sense, such a tool is instead a near incomprehensibly precise sequential specification of specific computational—machines—the parts of which are built up by activating/selecting such parts from typically more general computational machines over time (e.g., clocked time). This fact is sometimes obscured by the superficial similarities between high-level programming languages and natural languages. These superficial similarities also may cause a glossing over of the fact that high-level programming language implementations ultimately perform valuable work by creating/controlling many different computational machines.

The many different computational machines that a high-level programming language specifies are almost unimaginably complex. At base, the hardware used in the computational machines typically consists of some type of ordered matter (e.g., traditional electronic devices (e.g., transistors), deoxyribonucleic acid (DNA), quantum devices, mechanical switches, optics, fluidics, pneumatics, optical devices (e.g., optical interference devices), molecules, etc.) that are arranged to form logic gates. Logic gates are typically physical devices that may be electrically, mechanically, chemically, or otherwise driven to change physical state in order to create a physical reality of Boolean logic.

Logic gates may be arranged to form logic circuits, which are typically physical devices that may be electrically, mechanically, chemically, or otherwise driven to create a physical reality of certain logical functions. Types of logic circuits include such devices as multiplexers, registers, arithmetic logic units (ALUs), computer memory devices, etc., each type of which may be combined to form yet other types of physical devices, such as a central processing unit (CPU)—the best known of which is the microprocessor. A modern microprocessor will often contain more than one hundred million logic gates in its many logic circuits (and often more than a billion transistors). See, e.g., Logic Gates., Wikipedia. Wikimedia Foundation, 2 Apr. 2014. Web. 4 Feb. 2014.

The logic circuits forming the microprocessor are arranged to provide a microarchitecture that will carry out the instructions defined by that microprocessor's defined Instruction Set Architecture. The Instruction Set Architecture is the part of the microprocessor architecture related to programming, including the native data types, instructions, registers, addressing modes, memory architecture, interrupt and exception handling, and external Input/Output. See, e.g., Computer Architecture., Wikipedia. Wikimedia Foundation, 2 Feb. 2014. Web. 4 Feb. 2014.

The Instruction Set Architecture includes a specification of the machine language that can be used by programmers to use/control the microprocessor. Since the machine language instructions are such that they may be executed directly by the microprocessor, typically they consist of strings of binary digits, or bits. For example, a typical machine language instruction might be many bits long (e.g., 32, 64, or 128 bit strings are currently common). A typical machine language instruction might take the form “11110000101011110000111100111111” (a 32 bit instruction).

It is significant here that, although the machine language instructions are written as sequences of binary digits, in actuality those binary digits specify physical reality. For example, if certain semiconductors are used to make the operations of Boolean logic a physical reality, the apparently mathematical bits “1” and “0” in a machine language instruction actually constitute a shorthand that specifies the application of specific voltages to specific wires. For example, in some semiconductor technologies, the binary number “1” (e.g., logical “1”) in a machine language instruction specifies around +5 volts applied to a specific “wire” (e.g., metallic traces on a printed circuit board) and the binary number “0” (e.g., logical “0”) in a machine language instruction specifies around −5 volts applied to a specific “wire.” In addition to specifying voltages of the machines' configuration, such machine language instructions also select out and activate specific groupings of logic gates from the millions of logic gates of the more general machine. Thus, far from abstract mathematical expressions, machine language instruction programs, even though written as a string of zeros and ones, specify many, many constructed physical machines or physical machine states.

Machine language is typically incomprehensible by most humans (e.g., the above example was just ONE instruction, and some personal computers execute more than two billion instructions every second). See, e.g., Instructions per Second., Wikipedia. Wikimedia Foundation, 13 Jan. 2014. Web. 4 Feb. 2014.

Thus, programs written in machine language—which may be tens of millions of machine language instructions long—are incomprehensible. In view of this, early assembly languages were developed that used mnemonic codes to refer to machine language instructions, rather than using the machine language instructions' numeric values directly (e.g., for performing a multiplication operation, programmers coded the abbreviation “mult,” which represents the binary number “011000” in MIPS machine code). While assembly languages were initially a great aid to humans controlling the microprocessors to perform work, in time the complexity of the work that needed to be done by the humans outstripped the ability of humans to control the microprocessors using merely assembly languages.

At this point, it was noted that the same tasks needed to be done over and over, and the machine language necessary to do those repetitive tasks was the same. In view of this, compilers were created. A compiler is a device that takes a statement that is more comprehensible to a human than either machine or assembly language, such as “add 2+2 and output the result,” and translates that human understandable statement into a complicated, tedious, and immense machine language code (e.g., millions of 32, 64, or 128 bit length strings). Compilers thus translate high-level programming language into machine language.

This compiled machine language, as described above, is then used as the technical specification which sequentially constructs and causes the interoperation of many different computational machines such that humanly useful, tangible, and concrete work is done. For example, as indicated above, such machine language—the compiled version of the higher-level language-functions as a technical specification which selects out hardware logic gates, specifies voltage levels, voltage transition timings, etc., such that the humanly useful work is accomplished by the hardware.

Thus, a functional/operational technical description, when viewed by one of skill in the art, is far from an abstract idea. Rather, such a functional/operational technical description, when understood through the tools available in the art such as those just described, is instead understood to be a humanly understandable representation of a hardware specification, the complexity and specificity of which far exceeds the comprehension of most any one human. Accordingly, any such operational/functional technical descriptions may be understood as operations made into physical reality by (a) one or more interchained physical machines, (b) interchained logic gates configured to create one or more physical machine(s) representative of sequential/combinatorial logic(s), (c) interchained ordered matter making up logic gates (e.g., interchained electronic devices (e.g., transistors), DNA, quantum devices, mechanical switches, optics, fluidics, pneumatics, molecules, etc.) that create physical reality representative of logic(s), or (d) virtually any combination of the foregoing. Indeed, any physical object which has a stable, measurable, and changeable state may be used to construct a machine based on the above technical description. Charles Babbage, for example, constructed the first computer out of wood and powered by cranking a handle.

Thus, far from being understood as an abstract idea, it can be recognizes that a functional/operational technical description as a humanly-understandable representation of one or more almost unimaginably complex and time sequenced hardware instantiations. The fact that functional/operational technical descriptions might lend themselves readily to high-level computing languages (or high-level block diagrams for that matter) that share some words, structures, phrases, etc. with natural language simply cannot be taken as an indication that such functional/operational technical descriptions are abstract ideas, or mere expressions of abstract ideas. In fact, as outlined herein, in the technological arts this is simply not true. When viewed through the tools available to those of skill in the art, such functional/operational technical descriptions are seen as specifying hardware configurations of almost unimaginable complexity.

As outlined above, the reason for the use of functional/operational technical descriptions is at least twofold. First, the use of functional/operational technical descriptions allows near-infinitely complex machines and machine operations arising from interchained hardware elements to be described in a manner that the human mind can process (e.g., by mimicking natural language and logical narrative flow). Second, the use of functional/operational technical descriptions assists the person of skill in the art in understanding the described subject matter by providing a description that is more or less independent of any specific vendor's piece(s) of hardware.

The use of functional/operational technical descriptions assists the person of skill in the art in understanding the described subject matter since, as is evident from the above discussion, one could easily, although not quickly, transcribe the technical descriptions set forth in this document as trillions of ones and zeroes, billions of single lines of assembly-level machine code, millions of logic gates, thousands of gate arrays, or any number of intermediate levels of abstractions. However, if any such low-level technical descriptions were to replace the present technical description, a person of skill in the art could encounter undue difficulty in implementing the disclosure, because such a low-level technical description would likely add complexity without a corresponding benefit (e.g., by describing the subject matter utilizing the conventions of one or more vendor-specific pieces of hardware). Thus, the use of functional/operational technical descriptions assists those of skill in the art by separating the technical descriptions from the conventions of any vendor-specific piece of hardware.

In view of the foregoing, the logical operations/functions set forth in the present technical description are representative of static or sequenced specifications of various ordered-matter elements, in order that such specifications may be comprehensible to the human mind and adaptable to create many various hardware configurations. The logical operations/functions disclosed herein should be treated as such, and should not be disparagingly characterized as abstract ideas merely because the specifications they represent are presented in a manner that one of skill in the art can readily understand and apply in a manner independent of a specific vendor's hardware implementation.

At least a portion of the devices or processes described herein can be integrated into an information processing system. An information processing system generally includes one or more of a system unit housing, a video display device, memory, such as volatile or non-volatile memory, processors such as microprocessors or digital signal processors, computational entities such as operating systems, drivers, graphical user interfaces, and applications programs, one or more interaction devices (e.g., a touch pad, a touch screen, an antenna, etc.), or control systems including feedback loops and control motors (e.g., feedback for detecting position or velocity, control motors for moving or adjusting components or quantities). An information processing system can be implemented utilizing suitable commercially available components, such as those typically found in data computing/communication or network computing/communication systems.

The state of the art has progressed to the point where there is little distinction left between hardware and software implementations of aspects of systems; the use of hardware or software is generally (but not always, in that in certain contexts the choice between hardware and software can become significant) a design choice representing cost vs. efficiency tradeoffs. Various vehicles by which processes or systems or other technologies described herein can be effected (e.g., hardware, software, firmware, etc., in one or more machines or articles of manufacture), and that the preferred vehicle will vary with the context in which the processes, systems, other technologies, etc., are deployed. For example, if an implementer determines that speed and accuracy are paramount, the implementer may opt for a mainly hardware or firmware vehicle; alternatively, if flexibility is paramount, the implementer may opt for a mainly software implementation that is implemented in one or more machines or articles of manufacture; or, yet again alternatively, the implementer may opt for some combination of hardware, software, firmware, etc. in one or more machines or articles of manufacture. Hence, there are several possible vehicles by which the processes, devices, other technologies, etc., described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary. In an embodiment, optical aspects of implementations will typically employ optically-oriented hardware, software, firmware, etc., in one or more machines or articles of manufacture.

The herein described subject matter sometimes illustrates different components contained within, or connected with, different other components. It is to be understood that such depicted architectures are merely examples, and that in fact, many other architectures can be implemented that achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled, ” to each other to achieve the desired functionality, and any two components capable of being so associated can also be viewed as being “operably coupleable, ” to each other to achieve the desired functionality. Specific examples of operably coupleable include, but are not limited to, physically mateable, physically interacting components, wirelessly interactable, wirelessly interacting components, logically interacting, logically interactable components, etc.

In an embodiment, one or more components may be referred to herein as “configured to,” “configurable to,” “operable/operative to,” “adapted/adaptable,” “able to,” “conformable/conformed to,” etc. Such terms (e.g., “configured to”) can generally encompass active-state components, or inactive-state components, or standby-state components, unless context requires otherwise.

The foregoing detailed description has set forth various embodiments of the devices or processes via the use of block diagrams, flowcharts, or examples. Insofar as such block diagrams, flowcharts, or examples contain one or more functions or operations, it will be understood by the reader that each function or operation within such block diagrams, flowcharts, or examples can be implemented, individually or collectively, by a wide range of hardware, software, firmware in one or more machines or articles of manufacture, or virtually any combination thereof. Further, the use of “Start,” “End,” or “Stop” blocks in the block diagrams is not intended to indicate a limitation on the beginning or end of any functions in the diagram. Such flowcharts or diagrams may be incorporated into other flowcharts or diagrams where additional functions are performed before or after the functions shown in the diagrams of this application. In an embodiment, several portions of the subject matter described herein is implemented via Application Specific Integrated Circuits (ASICs), Field Programmable Gate Arrays (FPGAs), digital signal processors (DSPs), or other integrated formats. However, some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry or writing the code for the software and or firmware would be well within the skill of one of skill in the art in light of this disclosure. In addition, the mechanisms of the subject matter described herein are capable of being distributed as a program product in a variety of forms, and that an illustrative embodiment of the subject matter described herein applies regardless of the particular type of signal-bearing medium used to actually carry out the distribution. Non-limiting examples of a signal-bearing medium include the following: a recordable type medium such as a floppy disk, a hard disk drive, a Compact Disc (CD), a Digital Video Disk (DVD), a digital tape, a computer memory, etc.; and a transmission type medium such as a digital or an analog communication medium (e.g., a fiber optic cable, a waveguide, a wired communications link, a wireless communication link (e.g., transmitter, receiver, transmission logic, reception logic, etc.), etc.).

While particular aspects of the present subject matter described herein have been shown and described, it will be apparent to the reader that, based upon the teachings herein, changes and modifications can be made without departing from the subject matter described herein and its broader aspects and, therefore, the appended claims are to encompass within their scope all such changes and modifications as are within the true spirit and scope of the subject matter described herein. In general, terms used herein, and especially in the appended claims (e.g., bodies of the appended claims) are generally intended as “open” terms (e.g., the term “including” should be interpreted as “including but not limited to, ” the term “having” should be interpreted as “having at least, ” the term “includes” should be interpreted as “includes but is not limited to, ” etc.). Further, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, such recitation should typically be interpreted to mean at least the recited number (e.g., the bare recitation of “two recitations, ” without other modifiers, typically means at least two recitations, or two or more recitations). Furthermore, in those instances where a convention analogous to “at least one of A, B, and C, etc.” is used, in general such a construction is intended in the sense of the convention (e.g.,“a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense of the convention (e.g.,” a system having at least one of A, B, or C″ would include but not be limited to systems that have A alone, B alone, C alone, A and B together, A and C together, B and C together, and/or A, B, and C together, etc.). Typically a disjunctive word or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

With respect to the appended claims, the operations recited therein generally may be performed in any order. Also, although various operational flows are presented in a sequence(s), it should be understood that the various operations may be performed in orders other than those that are illustrated, or may be performed concurrently. Examples of such alternate orderings includes overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

While various aspects and embodiments have been disclosed herein, other aspects and embodiments are contemplated. The various aspects and embodiments disclosed herein are for purposes of illustration and are not intended to be limiting, with the true scope and spirit being indicated by the following claims.

1. A cannabis e-commerce device, comprising:
an e-commerce cannabis interface configured to receive cannabis experience information from a client device; and
a cannabis client interface configured to generate cannabis management information responsive to receiving the cannabis experience information.

2. The cannabis e-commerce device of claim 0, wherein the e-commerce cannabis interface includes circuitry configured to receive and store cannabis experience information from one or more of a smart device, a smart eyewear device, or a smart wearable device.

3. (canceled)

4. (canceled)

5. The cannabis e-commerce device of claim 0, wherein the e-commerce cannabis interface includes circuitry configured to receive and store cannabis experience information from one or more vaporizer devices.

6. The cannabis e-commerce device of claim 0, comprising:
a vaporizer device interface configured to negotiate an authorization protocol and to exchange cannabis experience information with a vaporizer device.

7. (canceled)

8. The cannabis e-commerce device of claim 0, comprising:
a vaporizer device interface configured to exchange cannabis management information with a vaporizer device.

9. The cannabis e-commerce device of claim 0, comprising:
a vaporizer pen interface configured to initiating a discovery and a registration protocol that allows the cannabis e-commerce device and vape pen device to find each other and negotiate one or more pre-shared keys.

10. The cannabis e-commerce device of claim 0, wherein the e-commerce cannabis interface includes circuitry configured to receive and store or more inputs indicative of a user-specific flavor profile.

11. The cannabis e-commerce device of claim 0, wherein the cannabis client interface includes circuitry configured to generate cannabis management information responsive to receiving the user-specific cannabis experience information.

12. (canceled)

13. (canceled)

14. The cannabis e-commerce device of claim 0, wherein the e-commerce cannabis interface includes circuitry configured to receive and store one or more inputs indicative of a user-specific pain mitigation profile.

15-31. (canceled)

32. A device, comprising:
circuitry configured to generate cannabis management information responsive to one or more inputs indicative of a user-specific cannabis management profile; and
circuitry configured to communicate cannabis management information to an associated client device.

33. The device of claim 0, comprising:
circuitry configured to associate cannabis management information to user-specific product information or to user-specific service information.

34. The device of claim 0, comprising:
circuitry configured to generate user-specific informatics regarding use and effectiveness responsive to one or more inputs indicative of a user-specific cannabis management profile.

35. The device of claim 0, comprising:
circuitry configured to communicate a notification to the associated client device responsive to a comparison of the one or more inputs indicative of a user-specific cannabis management profile to at least one threshold condition.

36. A method, comprising:
receiving cannabis experience information from a client device; and
generating cannabis management information responsive to receiving the cannabis experience information from the client device.

37. The method of claim 0, comprising:
negotiating an authorization protocol with a vaporizer device; and
exchanging cannabis experience information with the vaporizer device.

38. The method of claim 0, wherein receiving the cannabis experience information from the client device includes receiving desired feeling/results information from the client device.

39. The method of claim 0, wherein receiving the cannabis experience information from the client device includes receiving target cannabis flavor profile information from the client device.

40. (canceled)

41. The method of claim 0, wherein receiving the cannabis experience information from the client device includes receiving user-specific bioinformatics information from the client device.

42-44. (canceled)

45. The method of claim 0, wherein generating the cannabis management information includes generating target terpene/terpenoid composition information

46. The method of claim 0, wherein generating the cannabis management information includes generating target phyto-cannabinoid:terpene ratio information.

47-52. (canceled)
